(19) United States
(12) Patent Application Publication
(10) Pub. No.: US 2001/0010350 A1
(43) Pub. Date: Aug. 2, 2001

(54) Device for connection and mechanism for manoeuvring a closure or solar protection installation comprising such a device

(76) Inventor: Rino Cattaneo, Vedano Al Lambro (IT)

Correspondence Address: DOWELL & DOWELL PC, SUITE 309, 1215 JEFFERSON DAVIS HIGHWAY, ARLINGTON, VA, 22202

(21) Appl. No.: 09/760,672

(22) Filed: Jan. 17, 2001

(30) Foreign Application Priority Data
Jan. 31, 2000 (FR) 0001219

(51) Int. Cl. A47H 1/14; E06B 9/17

(52) U.S. Cl. 248/266; 248/254

(57) ABSTRACT

The device according to the present invention for connection between a roller shaft support and at least one slideway for laterally holding a shade body of a closure or solar protection installation, comprises at least one connection tab adapted to engage, on the one hand, with the slideway and, on the other hand, with the support. It is characterized in that it comprises an elastic member for locking the tab with the support by cooperation of shapes, this member comprising at least an elastically deformable first tongue equipped with a first beak adapted to clip against a surface of the tab and at least an elastically deformable second tongue equipped with a second beak adapted to clip against a surface of the support. This elastic member is adapted to form a stop against the displacement of the connection tab with respect to the support in a sense of separation of the tab with respect to the support.

### FIELD OF THE INVENTION

The present invention relates to a device for connection between a roller shaft support and slideways for laterally holding a shade body in a closure or sun protection installation. The invention also relates to a mechanism for manoeuvring a closure or sun protection installation comprising such a connection device.

Closure installation is understood to mean doors, gates, blinds and equivalent equipment.

### BACKGROUND OF THE INVENTION

EP-A-0 671 537 discloses a universal support for laterally guiding a roller blind, this support comprising interchangeable lateral rods or tabs intended to be inserted in a slideway for guiding a roller blind, being fixed in the lower part of a lateral face of a box. These interchangeable rods or tabs make it possible efficiently to position the slideways with respect to the box of the blind. However, it has appeared from experience that, when an installation comprising such a box and such slideways is positioned, it may happen that the aforementioned rods or tabs become detached from the bracket and drop to the floor, which means that the installer must stop positioning them in order to pick up the dropped element and replace it, such manipulations most often obliging the installer to get down from a ladder.

It is a more particular object of the present invention to overcome the problems set forth hereinabove by proposing a connection device which virtually eliminates the risks of a connecting tab being unhooked with respect to its environment when the closure installation is being positioned and used.

### SUMMARY OF THE INVENTION

To that end, the invention relates to a device for connection between a roller shaft support and at least one slideway for laterally maintaining a shade body of a closure or sun protection installation, which comprises at least one connection tab adapted to engage, on the one hand, with the slideway and, on the other hand, with the support. This device is characterized in that it comprises an elastic member for locking the tab with the support by cooperation of shapes, this member comprising at least an elastically deformable first tongue equipped with a first beak adapted to clip against a surface of the tab and at least an elastically deformable second tongue equipped with a second beak adapted to clip against a surface of the support, this elastic member being adapted to form a stop against a displacement of the tab with respect to the support in the sense of separation of the tab with respect to the support.

The elastic locking member or clip of the invention avoids an untimely disconnection of the connecting tab with respect to the support and therefore limits the risks of this tab, which is at least partially engaged inside the slideway in question, dropping.

According to advantageous but non-compulsory aspects of the invention, the device incorporates one or more of the following characteristics:

The elastic locking member comprises two substantially parallel first tongues each equipped with a beak adapted to clip against a surface of the tab, these beaks being oriented towards the outside of the tongues with respect to an intermediate space defined therebetween. The elastic clipping of the locking member on the tab may thus occur by an expansion of the tongues which may be compressed due to the geometry of the surfaces of the tab with which they cooperate. The second tongue may be provided to extend, from a zone forming a base common to the first tongues and to the second tongue, at least partially in a direction substantially parallel to the first tongues and outside the intermediate space mentioned above.

Each beak is bordered by a retaining surface substantially perpendicular with respect to a principal direction of the tongue in question and by a surface forming a ramp, inclined with respect to this principal direction. The inclined surface of each beak makes it possible to generate a progressive deformation of the tongue which bears it, during positioning of the elastic locking member.

The tab forms a housing for receiving the locking member, this housing defining at least one surface for cooperation with the beak of the first tongue. The support is advantageously provided with a heel projecting, from an end surface of the support and when the tab is in engagement on the support, towards the interior of the said housing, while this heel defines a surface adapted to cooperate with the beak of the second tongue. The housing may be provided with an opening for access to at least one of the beaks, this opening allowing the insertion of a means for disengaging this beak with respect to a corresponding surface of the support or of the tab. Thanks to this opening, it is possible to release the locking member with respect to the support or to the tab, which allows the installation to be dismantled.

The housing forms a stop adapted to abut against the locking member in place in the housing during a relative movement of the tab and of the support in a sense of separation of the tab and of the support.

The tab is adapted to be brought into engagement with the support by a translation in a direction and a sense defined by the cooperating parts of this support and this tab, this locking member being adapted to oppose, after engagement of the tab on the support, a translation of the tab with respect to the support in the same direction and in opposite sense.

The invention also relates to a mechanism for manoeuvring a closure or sun protection installation, which comprises a connection device as described hereinabove. Such a mechanism is simpler to install and to adjust than the mechanisms of the prior art.

### BRIEF DESCRIPTION OF THE DRAWINGS

The invention will be more readily understood and other advantages thereof will appear more clearly on reading the following description of an embodiment of a mechanism for manoeuvring a closure installation in accordance with its principle, given solely by way of example and made with reference to the accompanying drawings, in which:

FIG. 1 schematically shows a step of assembly of a mechanism for manoeuvring a roller blind according to the invention.

FIG. 2 is a view in perspective, on a larger scale and from the rear, of the mechanism of FIG. 1 in the course of assembly.

FIG. 3 is a view similar to FIG. 2 while the device is in assembled configuration.

FIG. 4 is a section along line IV-IV of FIG. 3.

FIG. 5 is a section along line V-V of FIG. 4.

FIG. 6 is a view in perspective on a larger scale of the elastic locking member used in the device of FIGS. 1 to 5.

FIG. 7 is a view in perspective in the same direction as FIG. 1 of the mechanism of FIG. 1 in the course of dismantling.

### DESCRIPTION OF PREFERRED EMBODIMENT

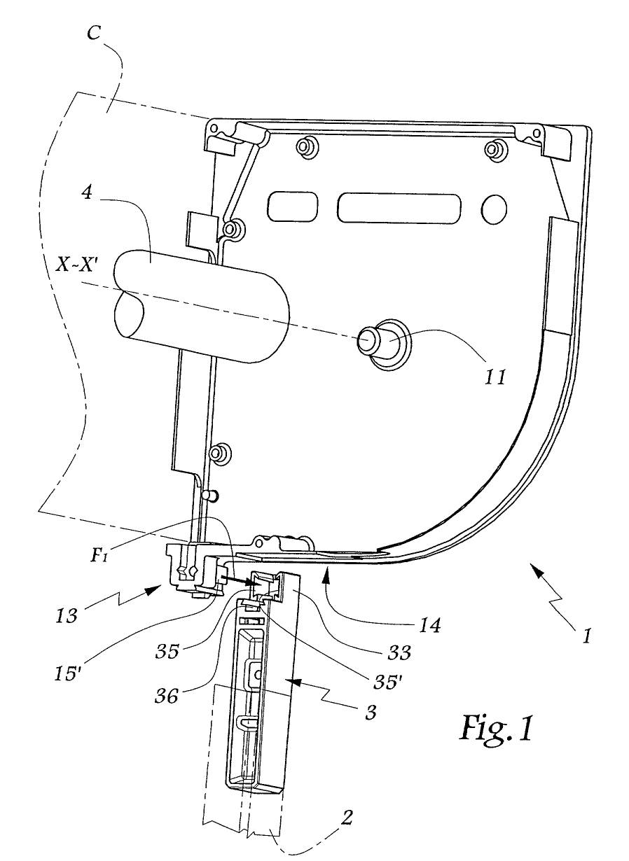

Referring now to the drawings, a roller blind box C is shown partially in dashed and dotted lines in FIG. 1 by its bottom board. An end bracket 1 of the box C is provided to be connected with a slideway 2 by means of a tab 3 partially engaged in the upper part of this slideway 2. The bracket 1 is equipped with a central projection 11 allowing it to support, directly or indirectly, a roller shaft 4 provided to rotate about a substantially horizontal axis X-X′.

In its lower part, the bracket 1 is provided with a projection 13 extending downwardly from the lower edge 14 of the principal part of the bracket 1 and forming elements in relief for hooking the tab 3. These elements in relief comprise two male dovetails 15 and 15′ disposed symmetrically on either side of a median plane P₁ of the projection 13. These elements in relief also comprise a lower male dovetail 16 extending over the whole length of the projection 13 while the male dovetails 15 and 15′ are limited by a stop 17.

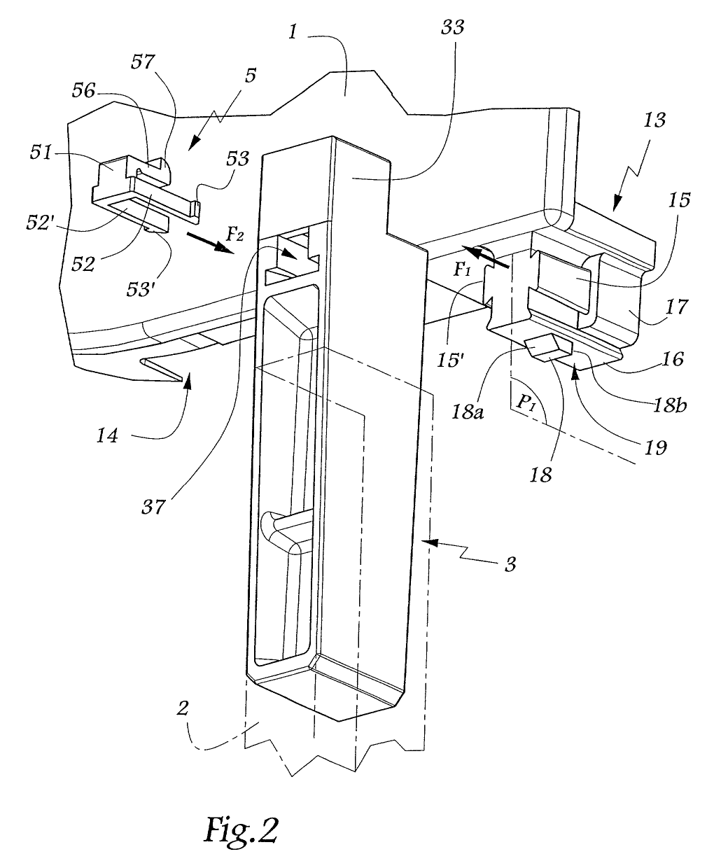

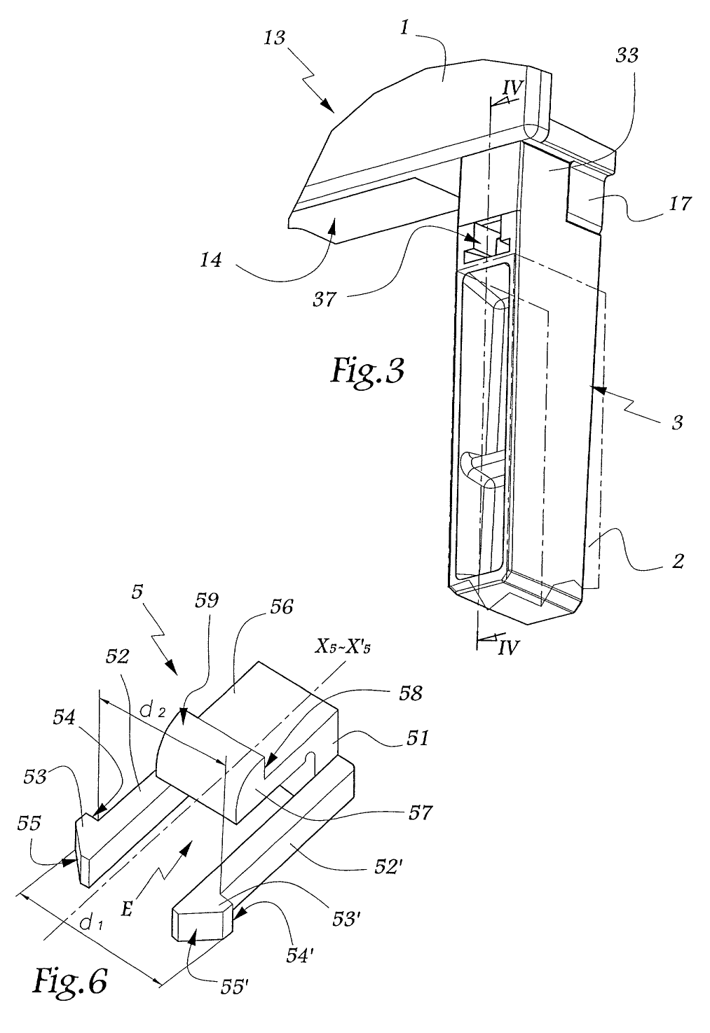

Recesses 35, 35′ and 36 in the form of a female dovetail are respectively provided in the upper part 33 of the tab 3 with a geometry complementary of that of the male dovetails 15, 15′ and 16. Elements 15, 15′, 16, 35, 35′ and 36 allow the projection 13 to hook on the tab 3 by a translation in the direction of arrows F₁ in FIGS. 1 and 2, the progress of the bracket 1 in the direction of arrows F₁ being limited by the stop 17.

According to the invention, an elastic locking member 5 is provided to immobilize the tab 3 in position engaged on the projection 13. This member is in one piece and moulded from plastics material. It comprises a base part 51 from which extend two tongues 52 and 52′ substantially parallel to a central axis X₅-X′₅ of the member 5 and between which is defined an intermediate space E. At its free end, each tongue 52 or 52′ is provided with a beak 53 or 53′ facing outwardly with respect to the space E and defined by a surface 54, 54′ respectively, substantially perpendicular to axis X₅-X′₅. Each beak 53, 53′ is also bordered by a surface 55, 55′ respectively, inclined with respect to axis X₅-X′₅.

From part 51 there also extends another tongue 56 of generally L-shaped section, with the result that it extends firstly in a direction substantially perpendicular to axis X₅-X′₅ then in a direction substantially parallel to this axis. At its end, the tongue 56 is provided with a beak 57 defined between a surface 58 perpendicular to axis X₅-X′₅ and a surface 59 inclined with respect to this axis.

A housing 37 is provided in part 33 of the tab 3 for receiving the member 5. This housing traverses right through the tab 5 and 37a denotes its opening on the side of tab 3 opposite the stop 17 when the tab 3 is mounted on the projection 13. e

The opening 37a comprises an upper part for passage of the tongue 56 and a substantially wider lower part for passage of the tongues 52 and 52′. As is more clearly seen in FIG. 5, the lower part of the opening 37a is convergent in the direction of the lower volume of the housing 37. In its entrance zone, the opening 37a has a width l₁ substantially equal to the distance d₁ separating the outer ends of the beaks 53 and 53′ of the member 5 at rest. The width of the lower part of the zone 37a decreases to a value 1₂ substantially equal to the distance separating the outer faces of the tongues 52 and 52′ in those parts where they do not comprise beaks.

When the member 5 is positioned in the housing 37, the tongues 52 and 52′ are deformed in the sense of approach or of narrowing of the space E by the cooperation of the inclined surfaces 55 or 55′ with the inclined introduction surfaces 37b and 37′b of the housing 37. Opposite the opening 37a, the housing 37 forms two shoulders 37c and 37′c for receiving the beaks 53 and 53′, the housings 37c and 37′c each being provided with a surface 37d or 37′d perpendicular to the direction F₂ of introduction of the member 5 into the housing 37.

In this way, when the beaks 53 and 53′ are in place in the shoulders 37c and 37′c, the member 5 is firmly held in position with respect to the tab 3 by cooperation of surfaces 54 and 37d, and 54′ and 37′d respectively.

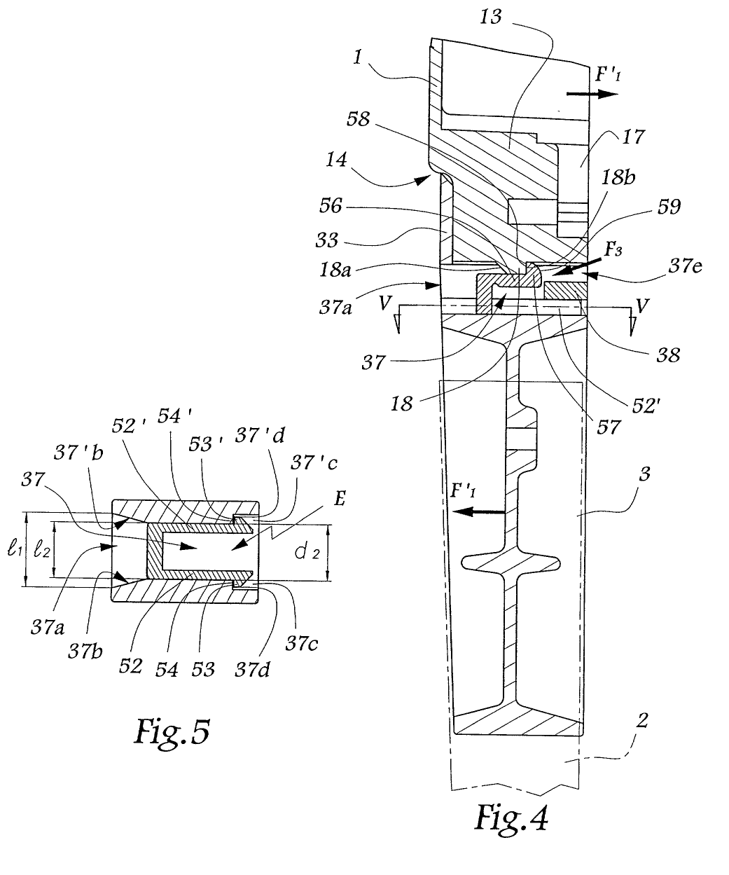

A heel 18 projects from the lower surface 19 of the projection 13. This heel comprises a surface 18a inclined with respect to the directions of arrows F₁ and F₂ and a surface 18b substantially perpendicular to these directions. The heel 18 is positioned so that, when the tab 3 is engaged on the projection 13 and when the member 5 is introduced into the housing 37, the surface 59 of the beak 57 slides against the surface 18a to such a point that the surface 58 of this beak is locked against the surface 18b by elastic deformation of the tongue 56, which guarantees a firm immobilization of the member 5 with respect to the projection 13 as shown in FIG. 4.

A rib 38 extends into the housing 37, transversely with respect to the direction of introduction of the member 5. This rib limits the movement of the member 5 in the direction of arrow F₂. Moreover, in the case of a beginning of relative movement of the tab 3 and the bracket 1, in the sense of moving apart or of separation of these elements, as represented by arrows F′₁ in FIG. 4, the rib 38 abuts against the beak 57 which is itself retained in position by the heel 18. As a result, the movement in the direction of arrows F′₁ is blocked by the cooperation of the rib 38 and the member 5.

In this way, the simple introduction of the member 5 into the housing 37 makes it possible to lock this member both with respect to the tab 3 and to the bracket 1 in a direction opposite arrows F₁ and F₂, which guarantees an efficient connection of the elements 1 and 3 in the direction of arrows F₁ and in the direction of arrows F′₁.

In practice, the member 5 is positioned in the housing 37 before the projection 13 is introduced in the recesses 35, 35′ and 36 of the tab 3, which induces the connection of elements 1 and 3. The assembly thus formed is then engaged in the slideway 2.

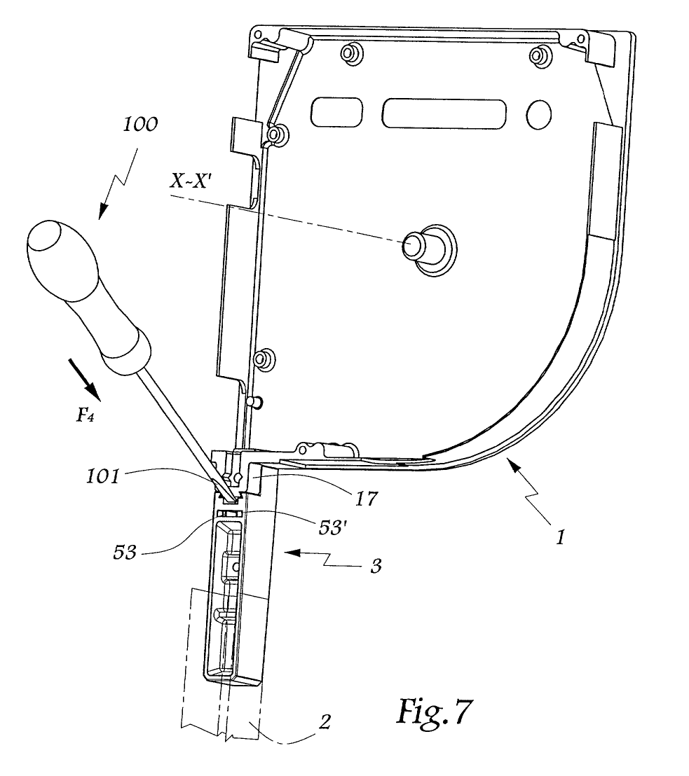

When the assembly thus produced is to be dismantled, the end of the screwdriver 100 can be introduced into the housing 37 through an opening 37e provided on the inner side of the tab 3 visible in FIGS. 1 and 7. The housing 37 is accessible by that side, as represented by arrow F₃ in FIG. 4, so that the tip 101 of the screwdriver 100 can exert on the beak 57 an effort of thrust F₄ making it possible to disengage the beak 57 with respect to the heel 18 and to separate the assembly formed by the tab 3 and the member 5 from the bracket 1 in the direction of arrows F′₁.

What is claimed is:

1. Device for connection between a roller shaft support and at least one slideway for laterally maintaining a shade body of a closure or sun protection installation, comprising at least one connection tab adapted to engage, on the one hand, with said slideway and, on the other hand, with said support, wherein it comprises an elastic member for locking said tab with said support by cooperation of shapes, said member comprising at least an elastically deformable first tongue equipped with a first beak adapted to clip against a surface of said tab and at least an elastically deformable second tongue equipped with a second beak adapted to clip against a surface of said support, said elastic member being adapted to form a stop against a displacement of said tab with respect to said support in a sense of separation of said tab with respect to said support.

2. The device of claim 1, wherein said member comprises two substantially parallel first tongues each equipped with a beak adapted to clip against a surface of said tab, said beaks being oriented towards the outside of said tongues with respect to an intermediate space defined between said tongues.

3. The device of claim 2, wherein said second tongue extends, from a zone forming a base common to said first and second tongues, at least partially in a direction substantially parallel to said first tongues and outside said intermediate space.

4. The device of claim 1, wherein each beak is bordered by a retaining surface substantially perpendicular with respect to a principal direction of the tongue in question and by a surface forming a ramp, inclined with respect to said principal direction.

5. The device of claim 1, wherein said tab forms a housing for receiving said locking member, said housing defining at least one surface for cooperation with said beak of said first tongue.

6. The device of claim 5, wherein said support is provided with a heel projecting, from an end surface of said support and when said tab is in engagement on said support, towards the interior of said housing and defining at least one surface adapted to cooperate with said beak of said second tongue.

7. The device of claim 5, wherein said housing is provided with an opening for access to a beak allowing the insertion of a means for disengaging said beak with respect to a corresponding surface of said support or of said tab.

8. The device of claim 5, wherein said housing forms a stop adapted to abut against said locking member in place in said housing during a relative movement of said tab and of said support in the sense of separation of said tab and of said support.

9. The device of claim 1, wherein the tab is adapted to be brought into engagement with said support by a translation in a direction and a sense defined by cooperating parts of said support and said tab, said locking member being adapted to oppose, after engagement of said tab on said support, a translation of said tab with respect to said support in the same direction and in opposite sense.

10. Mechanism for manoeuvring a closure or sun protection installation, wherein it comprises the connection device of claim 1.
